(19) United States
(12) Patent Application Publication
(10) Pub. No.: US 2024/0421534 A1
(43) Pub. Date: Dec. 19, 2024

(54) ELECTRICAL CONNECTOR, ELECTRICAL COUNTER-CONNECTOR AND CONNECTOR ASSEMBLY

(71) Applicant: Connecteurs Electriques Deutsch, Evreux Cede (FR)

(72) Inventors: Thierry CASSAR, Evreux Cedex (FR); Simon DELAIRE, Evreux Cedex (FR); Sébastien QUEVA, Evreux Cedex (FR)

(21) Appl. No.: 18/735,078

(22) Filed: Jun. 5, 2024

(30) Foreign Application Priority Data
Jun. 16, 2023 (EP) 23305964.1

(51) Int. Cl. H01R 13/627; H01R 13/502

(52) U.S. Cl. CPC H01R 13/6271; H01R 13/502

(57) ABSTRACT

An electrical connector includes a housing and an electrical terminal. The housing includes a connector locking device at least partially surrounding the shell, wherein the connector locking device is in a sliding contact with the shell thereby allowing a movement of the connector locking device along a mating axis relative to the shell. The connector locking device is configured to block a form-fit connection between a latching device of an electrical counter-connector and a protruding portion of the shell in a coupled state in which the electrical connector and the electrical counter-connector are coupled. A connector assembly includes the electrical connector and an electrical counter-connector configured to be mated with the electrical connector.

### CROSS REFERENCE TO RELATED APPLICATIONS

This application claims the benefit of EP application Ser. No. 23305964.1, filed 16 Jun. 2023, the subject matter of which is herein incorporated by reference in its entirety.

### BACKGROUND OF THE INVENTION

The subject matter herein relates to electrical connectors.

Connector systems are known in which an electrical connector and an electrical counter-connector are assembled to establish an electrical connection. In some applications, however, for example in vehicular, like aeronautical environments, vibrations on either or both sides of the connector system can lead to relative movements between the conductive electrical terminals, resulting in the degradation of the terminal interfaces called fretting.

To reduce fretting, some solutions propose connections in which the vibrations are absorbed attenuated before reaching the electrical connectors, for example, by spring-cushioning the installation of one or both of the electrical connectors. Spring-cushioned installations of connector systems can attenuate or absorb some of the oscillations and partially palliate the impact of vibrations, but some relative motions between the electrical terminals still occur.

There is a need for a connector coupling solution that reduces fretting.

### BRIEF DESCRIPTION OF THE INVENTION

In one embodiment, an electrical connector is provided including a housing and an electrical terminal that are configured to be mated along a mating axis with a mating housing and a mating electrical terminal of an electrical counter-connector. The housing of the electrical connector includes a shell at least partially surrounding the electrical terminal. The shell includes a protruding portion formed on an outward-facing surface for allowing a form-fit connection along the mating axis with a latching device, preferably hook-shaped, of the electrical counter-connector. The housing includes a connector locking device at least partially surrounding the shell, wherein the connector locking device is in a sliding contact with the shell thereby allowing a movement of the connector locking device along the mating axis relative to the shell. The connector locking device is configured to block the form-fit connection between the latching device and the protruding portion, in particular along a direction perpendicular to the mating axis, in a coupled state in which the electrical connector and the electrical counter-connector are coupled.

As the connector locking device is in sliding contact with the shell and at the same time blocks the form-fit connection of the shell with the latching device of the electrical counter-connector, the connector locking device can be used to absorb vibrations without transmitting them to the form fit connection to thereby reduce unwanted fretting. Specifically, the electrical connector can be installed in the environment such that the connector locking device receives the vibrations from the environment, slides along the shell accordingly, without impacting the form-fit connection along the mating axis between the connectors.

In various embodiments, an inward-facing surface, facing the outward-facing surface of the shell, of the connector locking device can form a receiving space together with the outward-facing surface of the shell, wherein the receiving space has an opening towards the protruding portion of the shell, the receiving space being configured to at least partially receive the latching device through the opening in the coupled state.

With a receiving space being formed between a surface of the connector locking device and a surface of the shell, the latching device of the electrical counter-connector, can be blocked from an unwanted movement away from the shell which could lead to a release of the form-fit connection when the connectors are fully coupled.

In various embodiments, the inward-facing surface of the connector locking device can comprise a first surface section parallel to the outward-facing surface of the shell, and, adjacent thereto, towards the opening of the receiving space, a second surface section, wherein the second surface section is chamfered with respect to the mating axis such that the distance between second surface section and the outward-facing surface of the shell gradually increases towards the opening.

During mating of the connector with the counter-connector, the chamfered surface section of the inward-facing surface of the locking device guides an extremity of the latching device received through the opening and bends it towards the shell. Once in the fully coupled state, the latching device contacts the first surface section. As the first surface section is parallel to the outward-facing surface of the shell, the locking device can slide along the shell without releasing the latching device.

In an embodiment, an electrical counter-connector includes a mating housing and a mating electrical terminal that are configured to be mated along a mating axis with a housing and an electrical terminal of an electrical connector according to one of the above-described aspects of the invention. The mating housing of the electrical counter-connector includes a mating shell at least partially surrounding the mating electrical terminal. The mating shell includes a hook-shaped latching device extending along an outward-facing surface of the mating shell and spaced apart therefrom. The latching device includes a lance extending in parallel to the mating axis and includes a mating protrusion extending from a surface of the lance facing the outward-facing surface of the mating shell towards said outward-facing surface of the mating shell, for allowing a form-fit connection along the mating axis with the protruding portion of the shell of the electrical connector. The lance of the latching device has one extremity fixed to the mating shell and a second extremity of the lance is configured and arranged such that in the coupled state, the second extremity of the lance is blocked, in particular along the direction perpendicular to the mating axis, by the connector locking device of the electrical connector.

This configuration of an electrical counter-connector may be suited for coupling with the above-described aspects of the inventive electrical connector, as the connector locking device blocks the lance, thus locking the latching device to the shell, and by extension locking the connector with the electrical counter-connector. In particular, the lance can be blocked along the direction perpendicular to the mating axis without impeding a sliding movement of the connector locking device along the mating axis while the connectors are in the coupled state.

In various embodiments, the lance of the electrical counter-connector can extend perpendicularly from a flange mounted against a mating flange of the mating shell. In this configuration, the latching device can be deported from the mating shell of the connector to a flange that is externally mounted, facilitating the elastic bending of the latching device. In addition, using a flange to provide the lance, the invention can be realized by reusing standardized electrical counter-connectors already being equipped with a mating flange.

In various embodiments, the latching device can comprise a notch formed at the second extremity on an outward-facing surface opposite the surface of the lance facing the outer surface of the mating shell. The notch can facilitate form-fitting of the latching device with shapes of the inward-facing surface of the connector locking device, for example the first, parallel, and second, chamfered, surface sections of the inward-facing surface of the connector locking device.

In various embodiments, the notch can be configured such that in the coupled state, a surface of the notch is engaged with the first surface section, and/or can be configured such that in the coupled state a surface of the notch is parallel to the outward-face surface of the shell. Thus, the form-fit connection between the lance and the connector locking device is improved.

In an embodiment, a connector assembly is provided including an electrical connector according to any one above-described aspects of the electrical connector, and an electrical counter-connector according to any one of above-described aspects of the electrical counter-connector. The electrical connector is coupled to the electrical counter-connector, wherein the electrical terminal of the electrical connector abuts against the mating electrical terminal, in particular in a plane perpendicular to the mating axis. The protruding portion and the mating protrusion realize a form-fit connection between the latching device and the shell along the mating axis, in particular to prevent a decoupling against the coupling direction, and the second extremity of the lance is blocked by the connector locking device in the direction perpendicular to the mating axis away from the shell of the electrical connector.

When the electrical connector and the electrical counter-connector are assembled in this configuration, the abutment of the electrical terminal of the electrical connector with the mating terminal of the electrical counter-connector is safeguarded and preserved by the blocking of the form-fitted latching of the latching device on the shell by the connector locking device. Specifically, movement of the electrical terminal relative to the mating electrical terminal is blocked in one direction along the mating axis by the abutment of the terminals, and in the opposed direction along the mating axis by the form-fit connection of the latching device with the protruding portion. As the connector locking device has a degree of freedom along the mating axis in a sliding contact along the shell of the electrical connector, the connector locking device can absorb vibrations externally induced on the electrical assembly connection, for example by mounting equipment, while securing the electrical connection. In this way, fretting corrosion is reduced and the quality of the electrical connection is improved.

In one aspect, the lance of the latching device can be bent towards the shell of the electrical connector by the connector locking device. In particular, the lance of the latching device can be bent towards the shell of the electrical connector by the inward-facing surface of the connector locking device. By bending the latching device towards the shell, the mating protrusion is pushed against the protruding portion and the form-fit connection along the mating axis is even further strengthened.

In one aspect, the form-fit connection between the latching device and the connector locking device can be realized by a planar engagement between the notch and the second surface portion. The parallel shape of the second surface portion with respect to the shell surface and the matching parallel shape of the notch allows for a form-fit connection which remains in place but allows at the same time the movement of the locking device relative to the shell and at the same. Thus, the engagement at the interface of the notch and the second surface portion can allow relative movements along a plane parallel to the mating axis between the connector assembly on one hand and the connector locking device in contact with external environment and/or devices on the other hand.

In one aspect, the connector assembly can comprise a rack for mounting the connector assembly to an external device, in particular a vehicular device, such that the connector assembly has one or more degrees of freedom when mounted to the external device, wherein the electrical connector is located in an opening of the rack such that the rack partially extends between a flange of the shell and the connector locking device, wherein the rack is moveable with respect to the shell and frictionally and/or positively engaged with the connector locking device, wherein the lance remains moveably blocked by the connector locking device over a predetermined linear range of the relative position of the rack with respect to the shell along the mating axis.

In the presence of vibrations on the rack, the connector locking device of the electrical connector vibrates together with the rack, with which it is positively and/or frictionally engaged. However, those vibrations are absorbed by the movability of the locking device with respect to the shell, while keeping the blocking of the lance in place and thereby also keeping the form-fit connection in place. Thus, the vibrations will not lead to a relative movement between the electrical terminals and will not lead to a relative movement between the shell and the mating shell.

According to this aspect, the connector assembly is advantageously compatible with racked connections. Indeed, the electrical connector can be configured as mobile connector and be mounted floating in the rack, that is, moveable with respect to the rack.

### BRIEF DESCRIPTION OF THE DRAWINGS

The above-described or mentioned objects and advantages, as well as further objects and advantages, of this invention will be more completely understood and appreciated by careful study of the following more detailed description of exemplary aspects and embodiments of the invention. The following description shall be taken in conjunction with accompanying drawings, in which:

FIG. 1 shows a perspective view of an electrical connector according to an embodiment of the invention including a rack, and an electrical counter-connector according to an embodiment of the invention, in a separated state.

FIG. 2A shows a perspective view of the electrical connector of FIG. 1, without the rack.

FIG. 2B shows a cross-sectional view of the electrical counter-connector of FIG. 1.

FIG. 3A shows a cross-sectional view of the electrical connector of FIG. 1, including the rack.

FIG. 3B shows a cross-sectional view of connector locking device of the electrical connector of FIG. 1.

FIG. 4A shows a cross-sectional view of a peripheral portion of the connectors of FIG. 1, in a first, unmated state of coupling.

FIG. 4B shows a cross-sectional view of a peripheral portion of the connectors of FIG. 1, in a second, intermediate state of coupling.

FIG. 4C shows a cross-sectional view of a peripheral portion of the connectors of FIG. 1, in a third, coupled state of coupling.

FIG. 5 shows a cross-sectional view of the connectors and the rack of FIG. 1, in a coupled state.

FIG. 6A shows a close-up view of a section of FIG. 5, in a first vibrational state.

FIG. 6B shows a close-up view of a section of FIG. 5, in a second vibrational state.

In the drawings, identical reference signs or reference numbers used in different figures relate to identical elements, unless indicated otherwise in the description. In addition, the described or mentioned embodiments, alternatives, options, variants and perfections, and their respective features, can be freely combined, respectively independently from each other.

### DETAILED DESCRIPTION OF THE INVENTION

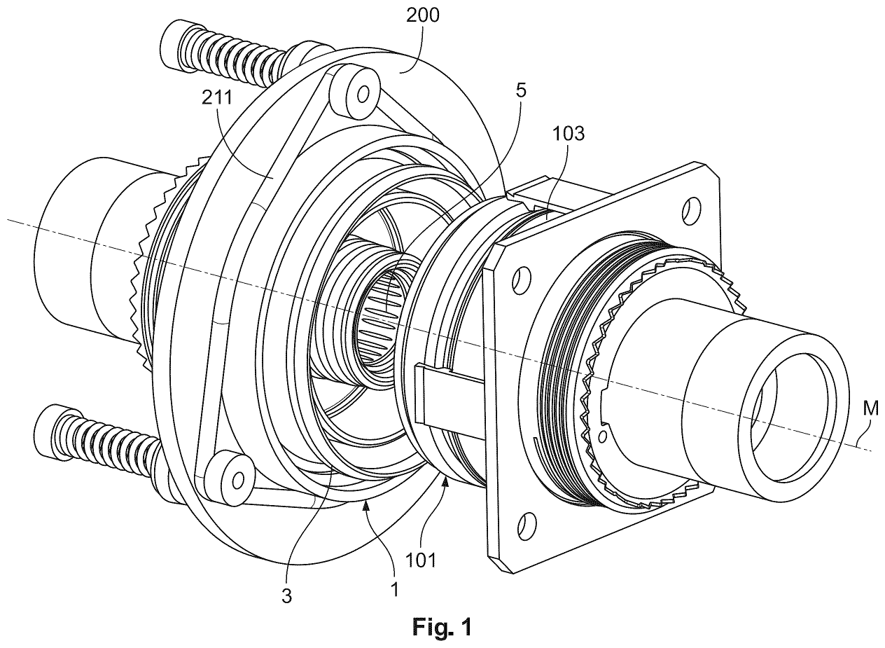

FIG. 1 shows an electrical connector 1 according to an exemplary embodiment and an electrical counter-connector 101 according to an exemplary embodiment in a perspective view prior to coupling along a mating axis M.

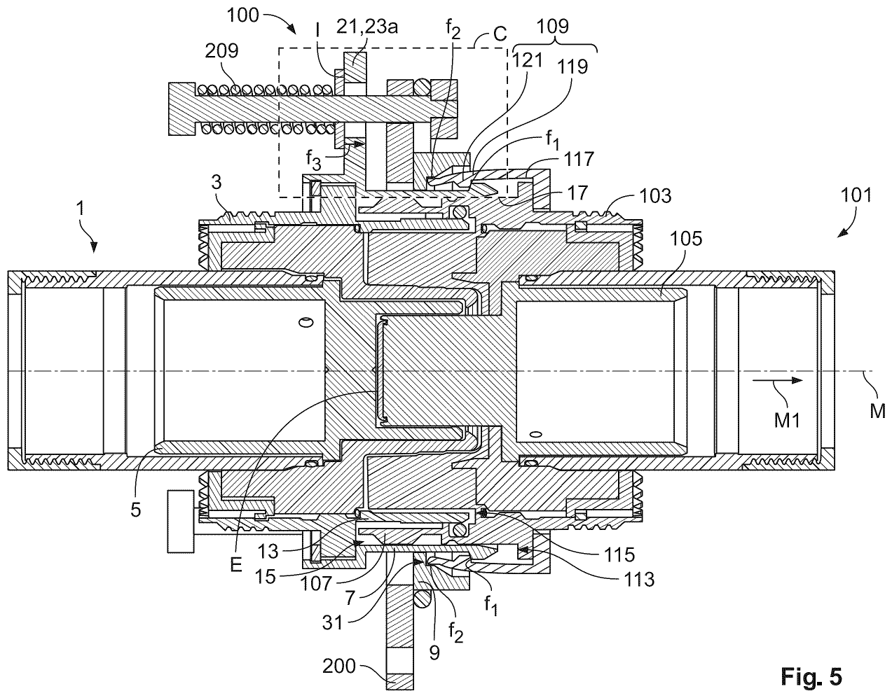

The electrical connector 1 and the electrical counter-connector 101 are suited to be coupled together to establish an electrical connection, as will be described later. In the coupled state, the electrical connector 1 and electrical counter connector 101 are assembled in a connector assembly 100, represented in FIG. 5, according to an exemplary embodiment.

The electrical connector 1 and electrical counter connector 101 can be power connectors, in particular high-power connectors, for example configured for electrical currents of 50 A and above. The electrical connector 1 and electrical counter connector 101 can be configured for power applications in an electrical vehicle, in particular an electrical aircraft. The electrical counter-connector 101 can be a fixed-side, immobilized socket connector mounted to a frame of the vehicle, while the electrical connector 1 is a mobile-side, unfixed plug connector, connected to an external device of the vehicle. However, in variants, the electrical connector 1 can be a fixed-side connector, and the electrical counter-connector 101 can be a mobile-side connector, or both can be mobile-side connectors. The electrical connector 1 and the electrical connector 101 are both cylindrically shaped, in particular cylindrically formed along the mating axis M. However, the shape of the connectors 1, 101 is not limited thereto and may be applicable to connectors having other shapes, for example cuboid shapes.

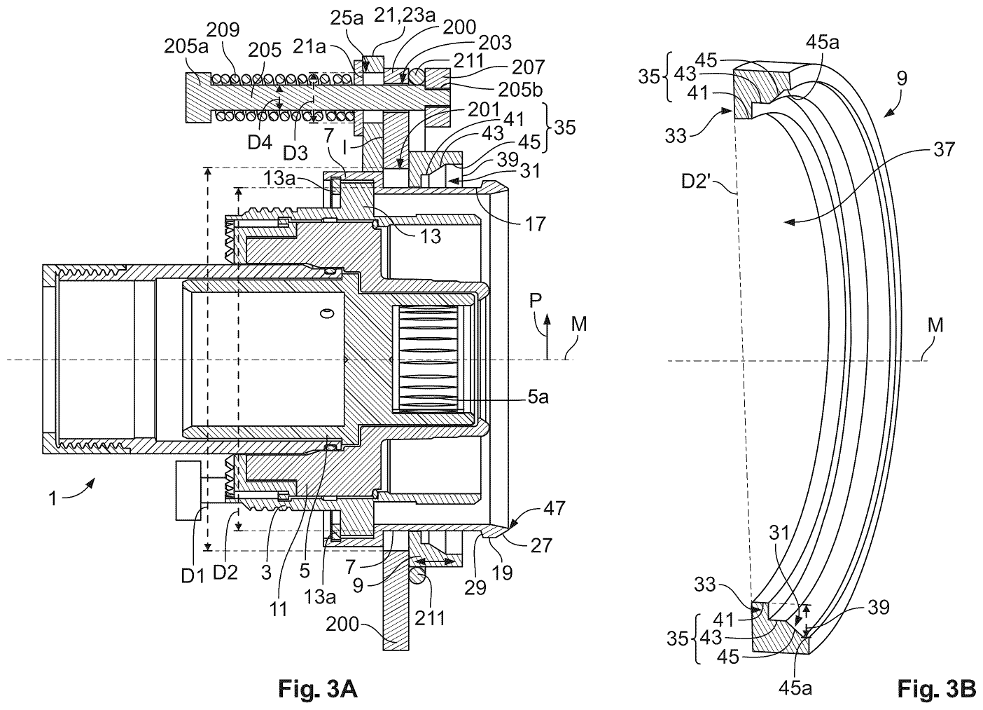

To connect the electrical connector 1 to the external device, the electrical connector 1 is mounted on a rack 200 such that the connector 1 has one or more degrees of freedom, which shall be further described in the following. The rack 200 is only partially represented in the figures for ease of illustration, here by a plane rack wall section having a circular shape, even though other shapes are possible. As will be further described with respect to FIG. 3A, the housing 3 of the electrical connector 1 is received in a primary rack opening having a diameter larger than a diameter of a shell of the connector 1, such that the connector 1 is moveable with respect to the rack 200, to an extent determined by the difference in diameters, in directions P, P′ perpendicular to the mating axis M. Optionally, and an elastic device 211 can help center the housing 3 in the primary rack opening and/or create a frictional fit of the connector 1 along the mating axis M.

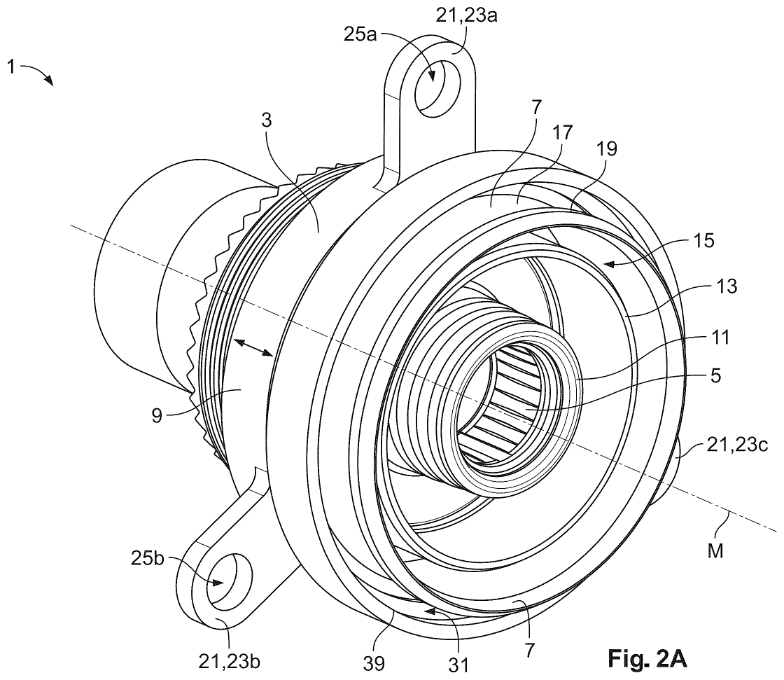

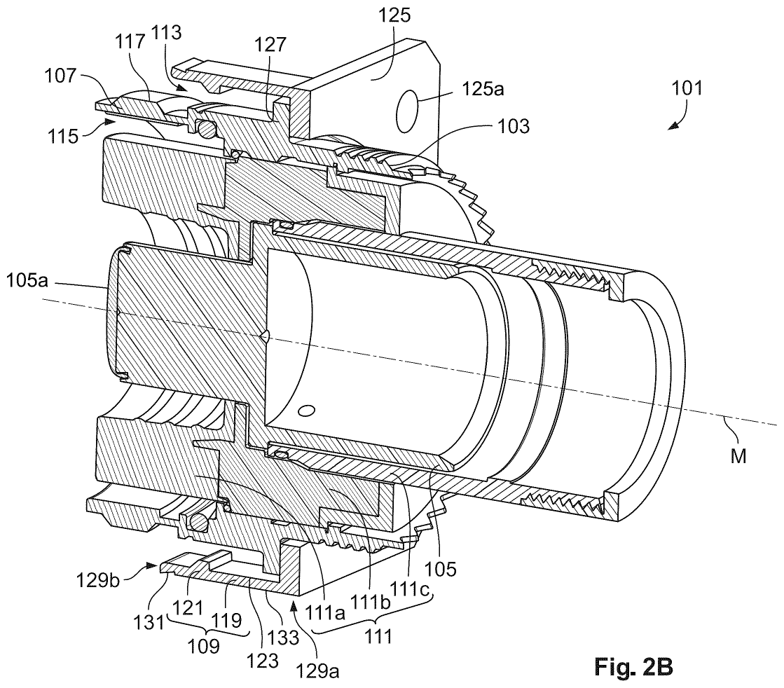

The electrical connector 1 comprises a housing 3 and an electrical terminal 5. The electrical counter-connector 101 comprises a mating housing 103 and a mating electrical terminal 105, which are configured to be mated respectively along the mating axis M, when the connectors 1, 101 are mated along the mating axis M. The mating terminal 105 is not visible on FIG. 1 but illustrated on FIG. 2B.

In the presently described embodiments, the represented connector 1 and the counter connector 101 comprise only one terminal each, respectively the electrical terminal 5 and the mating electric terminal 105. However, the subject matter herein is not limited to connectors and connector assemblies involving only one electrical terminal per connector. Instead, the subject matter herein is also applicable to connectors comprising a greater number of respective electrical terminals, for example two, three or four electrical terminals on each connector that are configured to be mutually mated.

The electrical connector 1 and the mating electrical connector, 101 will now be described in more detail with reference to FIGS. 2A and 2B. FIG. 2A shows the electrical connector 1 in a perspective view, alone, without the rack 200 of FIG. 1. The housing 3 of the connector 1 comprises a shell 7, a connector locking device 9, an insulating insert 11, in particular a thermoplastic insulator, and an inner casing 13. The shell 7 surrounds the inner casing 13, that is, the shell 7 envelops a peripheral circumference, in a plane orthogonal to the mating axis M, of the inner casing 13. Specifically, the shell 7 surrounds the inner casing 13 such that a coupling space 15 is formed there-between.

Similarly, the inner casing 13 surrounds the insulating insert 11. The insulating insert 11 is fit in the inner casing 13, and the inner casing 13 is fit in the shell 7. FIG. 2A shows that the electrical terminal 5 is a female, or socket, contact terminal configured to receive a male, or plug, electrical terminal, and that the electrical terminal 5 is fit in the insulating insert 11 such that the terminal 5 can receive the mating terminal. According to a variant, the electrical terminal 5 could be a male contact terminal configured to receive a female electrical terminal.

The connector locking device 9 surrounds the shell 7, that is, the connector locking device 9 envelops a peripheral circumference, in a plane orthogonal to the mating axis M, of the shell 7. However, the connector locking device 9 is in a sliding contact with the shell 7, and is moveable along the mating axis M relative to the shell 7, which shall be further described in the following.

The shell 7 comprises a protruding portion 19 formed on an outward-facing surface 17 of the shell 7, that is, a surface facing away from the surrounded electrical terminal 5. Specifically, the protruding portion 19 is formed along a radial circumference of the shell 7 with respect to the mating axis M, protruding outwardly. Here, the protruding portion 19 is formed at the distal extremity of the shell 7 along the mating axis M on the mating side, facing towards the electrical counter-connector 101 to be mated with, as illustrated in FIG. 1. The protruding portion 19 is configured to realize a form-fit connection along the mating axis with a latching device 109 of the electrical counter-connector 101.

The shell 7 also comprises a flange 21 for mounting the electrical connector 1 to the rack 200 as illustrated in FIG. 1. Here, the flange 21 is not a fully circumferential flange but instead merely comprises three flange portions 23a, 23b, 23c, protruding outwardly with respect to the mating axis M at the same position but at different angular dispositions with respect to the mating axis M. For example, here, the flange portions 23a, 23b, 23c, protrude from three different directions, each rotated by 120° with respect to the other two directions. The flange portions 23a, 23b, 23c are formed in one piece with the rest of the shell 7. Each flange portion 23a, 23b, 23c, comprises a respective bore 25a, 25b formed therein and extending in parallel to the mating axis M.

FIG. 2B shows a cross-sectional view of the electrical counter-connector 101 along the mating axis M. The mating housing 103 comprises a mating shell 107 and a mating insulating insert 111, in particular a thermoplastic insulator, comprising here an interfacial insulation body 111a, a secondary insulation layer 111b and a terminal holder 111c. The mating shell 107 surrounds the mating insulating insert 111, that is, envelops a peripheral circumference, in a plane orthogonal to the mating axis M, of the mating insulating insert 111. Specifically, the mating shell 107 surrounds the mating insulating insert 111 such that a mating coupling space 115 is formed there-between.

The mating insulating insert 111 is fit in the mating shell 107. FIG. 2B shows that the mating electrical terminal 105 is a male, or plug, contact terminal configured to be received in a female contact terminal, for example terminal 5. According to an alternative, the mating electrical terminal 105 could also be a female contact terminal configured to receive a male contact terminal. The mating electrical terminal 105 is fit in the mating insulating insert 111 such that the mating electrical terminal 105 is inserted in the terminal 5 when the electrical connector 1 and electrical counter connector 101 are mated. In order to touch-proof the mating electrical terminal 105, a terminal insulating device 105a 1distally mounted thereon.

In a variant where the connectors 1, 101 respectively hold a plurality of terminals each, the rotational position of the terminals around the mating axis M may displaced due to a rotational degree of freedom of either one or both of the connector 1, 101. In case of such an angular displacement between a plurality of terminals of the connector 1, and a plurality of terminals of the connector 101, the alignment can be nevertheless facilitated by providing matching shapes between the insulating insert 11 and the mating insulating insert 111. Specifically, mating insulating insert 111 can be configured to guide the insulating insert 11 during mating of the housings 3, 103 such that the angular positions of the terminals 5, 105 are realigned. For example, the insulating insert 11 can be provided in a conic shape around the terminals of the electrical connector, and the mating insulating insert 111 can be provided in an inverse conic shape around the mating terminals of the electrical counter-connector.

The mating housing 103 comprises a latching device 109. The latching device 109 is hook-shaped and extends along an outward-facing surface 117 of the mating shell 107, that is, a surface facing away from the mating electrical terminal 105. The latching device 109 extends along the outward-facing surface 117 spaced apart therefrom, providing a latching space 113 between the latching device 109 and the outward-facing surface 117.

The latching device 109 comprises a lance 119 extending in parallel to the mating axis M, and a mating protrusion 121, protruding therefrom. In particular, the mating protrusion 121 extends from a surface 123 facing the outward-facing surface 117 of the mating shell 107, towards said outward-facing surface 117.

The mating housing 103 further comprises a flange 125, and the mating shell 107 comprises a mating shell flange 127. The mating shell flange 127 protrudes circumferentially radially outwards with respect to the mating axis M, and the flange 125 is mounted, in particular form-fit or friction-fit against the mating shell flange 127. Preferably, the flange 125 is mounted to the mating shell flange 127 by a bolt connection via flange through holes 125a.

The lance 119 extends perpendicularly from the flange 125, wherein a first extremity 129a of the lance 119 is fixed to the flange 125 mounted on the mating shell 107. A second extremity 129b is free and is elastically bendable with respect to the first extremity 129a. The lance 119 extends from the flange 125 such that the second, free, extremity 129b faces towards the side of the electrical counter-connector 101 configured to be mated with the electrical connector 1. The latching device 109 further comprises a notch 131, formed between the first 129a and second extremity 129b, on the outward-facing surface 133 of the lance 119, whose function hall be further described in the following. The notch 131 is formed closer to the second extremity 129b than the mating protrusion 121.

FIG. 3A shows a cross-sectional view of the electrical connector 1 already described with respect to FIG. 2A, here mounted to the rack 200 shown in FIG. 1 and described in reference thereto. As seen in the cross-sectional view of FIG. 3A, the distal extremity 47 of the shell 7 facing towards the side of the electrical connector 1 configured to be mated with the electrical counter-connector 101 is chamfered inwardly to facilitate a guiding of the mating shell 107 into the coupling space 15 when the electric connector 1 is coupled to the counter electrical connector 101.

The protruding portion 19 comprises a second chamfered part 27, facing towards the side of the electrical connector 1 configured to be mated with the electrical counter-connector 101, and a step part 29, facing away from the side of the electrical connector 1 configured to be mated with the electrical counter-connector 101. The chamfered part 27 is configured to facilitate the elastic bending outwards of the latching device 109 when the electrical connector 1 is coupled to the counter electrical connector 101. The step part 29 is configured to facilitate a latching with the mating protrusion 121 of the latching device 109.

FIG. 3A shows that in this embodiment, the inner casing 13 and the shell 7 are separate parts, wherein the inner casing 13 is form-fit in the shell 7. Specifically, the inner casing 13 is inserted and received in the shell 7 and then secured in the shell 7 by a retainer ring, or circlip, 13a. The inner casing 13 holds the terminal 5, here configured as a socket terminal equipped with a stamped metal strip 5a, known as louvered contact band. The metal strip 5a has louver-shaped contact bridges in parallel along of the strip 5a, to improve electrical connection, in particular with respect to number of contact points and the contact pressure.

As mentioned with reference to FIG. 1, electrical connector 1 is configured to be mounted on the rack 200, by means of the flange 21, including the flange portions 23a, 23b, and 23c. FIG. 3A shows the rack 200, represented here as a rack wall portion, in a cross-sectional view. The rack 200 comprises one primary rack opening 201 for receiving the housing 3, in particular the shell 7, of the electrical connector 1. The diameter D1 of the rack opening 201 is larger, in particular at least 3%, preferably more than 6%, larger than the diameter D2 of the outward-facing surface 17 of the shell 7. Thus, the shell 7 of the electrical connector 1 can be received in rack opening 201, and be movable therein. Specifically, the electrical connector 1 can be movable in the rack opening 201 rotationally around the mating axis M, translationally along the mating axis M, and/or translationally along at least one direction P this perpendicular to the mating axis M.

The rack 200 further comprises mounting holes 203 in positions surrounding the rack opening 201 and matching the positions of the bores 25a of the flange portions 23a surrounding the shell file. Specifically, the mounting holes 203 are centrally aligned with the bores 25a when the electrical connector 1 is centrally aligned in the rack opening 201 along the mating axis M. In addition, the mounting holes 203 have a diameter D4 that is smaller, in particular at least 10% smaller, than the diameter D3 of the bores 25a.

The electrical connector 1 is mounted to the rack 200 with pins 205, here with three pins matching the number of flange portions 23a, 23b, 23c, but only one visible in FIG. 3a, and the number of corresponding mounting holes 203. The pins 205 are inserted through the bores 25a and the mounting holes 203 such that the flange portions 23a of the housing 3 of the electrical connector 1 are movable along and around the pin 205. The pin 205 has a pin head 205a at a first extremity and a threaded portion 205b at a second extremity, the threaded portion 205 being configured to be screwed with a screw nut 207.

The electrical connector 1 is mounted to the rack 200, of which only a rack wall section is represented in the drawings, is located and extends between the flange 21 of the housing 3 and the connector locking device 9 of the housing 3.

At the first extremity, a coil spring 209 is attached to the pin head 205a and wound around the pin 205 until reaching a back surface 21a of the flange 21. The coil spring 209 is selected and arranged on the pin 205 in a preloaded or compressed state, such that the spring bias always exerts a force on the back surface 21a of the flange 21, with respect to the pin head 205a.

By extension, the coil spring 209 presses the flange 21 along the mating axis M against the rack 200, creating an engagement interface I. Optionally, an elastic device 211, such as a spring or band, can be arranged around a peripheral outline of the positions of the pins 205 in order to center the housing 3 in the center of the rack opening 201 and to frictionally engage the rack 200 with the housing 3, specifically with the connector locking device 9, which is in sliding contact along the mating axis M with the shell 7 received in the rack opening 201. In variants, a different device can be used to positively engage the connector locking device 9 with the rack 200. The connector locking device 9 is annular, or ring-shaped, and arranged surrounding the shell 7 so as to be in sliding contact with the outward-facing surface 17 of said shell 7, allowing relative movement along the mating axis M with respect to the shell 7. Specifically, the connector latching device 9 is arranged surrounding the shell 7 such that a receiving space 31 is formed between the outward-facing surface 17 of the shell 7 and an inward-facing surface 35 of the connector latching device 9.

The connector locking device 9 is illustrated separately in more detail in FIG. 3B. FIG. 3B shows a cross-sectional cut view, along a plane collinear with the mating axis M, of the connector latching device 9. The diameter D2′ of the central opening 37 of the ring-shaped connector locking device 9, defined by an innermost surface 41 of a sliding section 33 of the connector locking device 9, is selected with respect to the diameter D2 such that a sliding contact between the connector locking device 9 and the shell 7 is enabled. That is, the diameter D2′ corresponds to the diameter D2 or between 0.1% and 1% larger than the diameter D2 of the outward-facing surface 17 of the shell 7.

The ring-shaped connector locking device 9 comprises an inward-facing surface 35, that is, a surface facing towards the central opening 37 of the ring-shaped connector locking device 9, and towards the shell 7 arranged therein. The inward-facing surface 35 is configured to form a receiving space 31 with the shell 7 that has a receiving opening 39 towards the protruding portion 19 for the receiving of the latching device 109 when the electrical connector 1 and electrical counter connector 101 are coupled.

The inward facing surface 35 comprises a first surface section 43 and a second surface section 45. The first surface section 43 is parallel to the mating axis M and parallel to the inward-facing surface 17 of the shell 7. The second surface section 45 is adjacent to the first surfaced section 43 towards the receiving opening 39. The second surface section 45 is chamfered with respect to the mating axis M such that the distance between the second surface section 45 and the mating axis M and a more outward facing surface 17 of the shell 7 gradually increases towards the receiving opening 39. A third surface section 45a can be provided adjacent to the second surface section 43 towards the receiving opening 39, configured to secure the lance 119 in the receiving space 31 and prevent and outward bending of the lance 119.

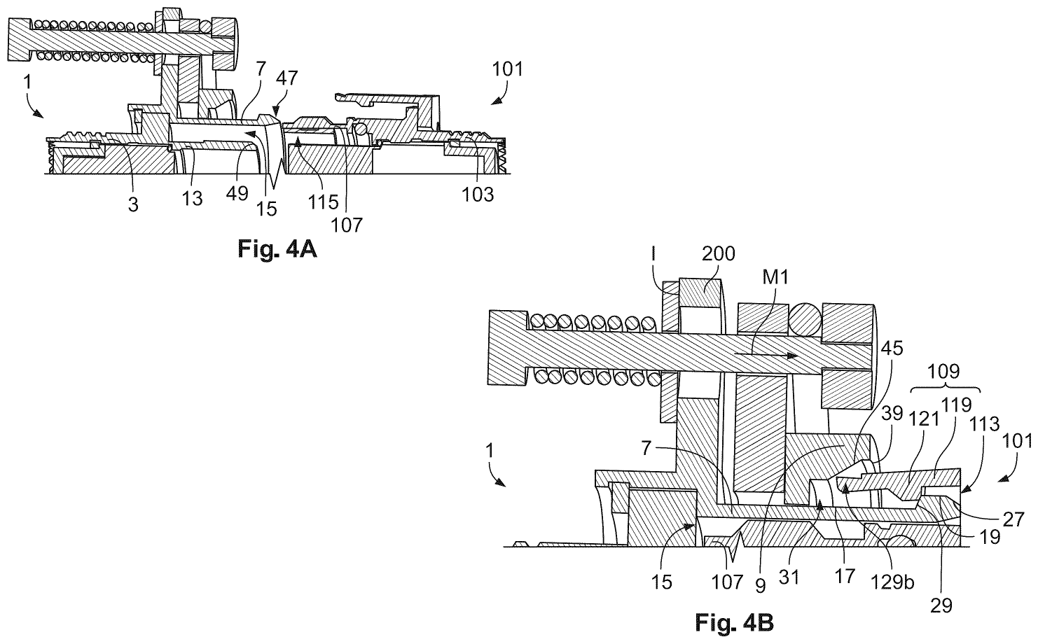

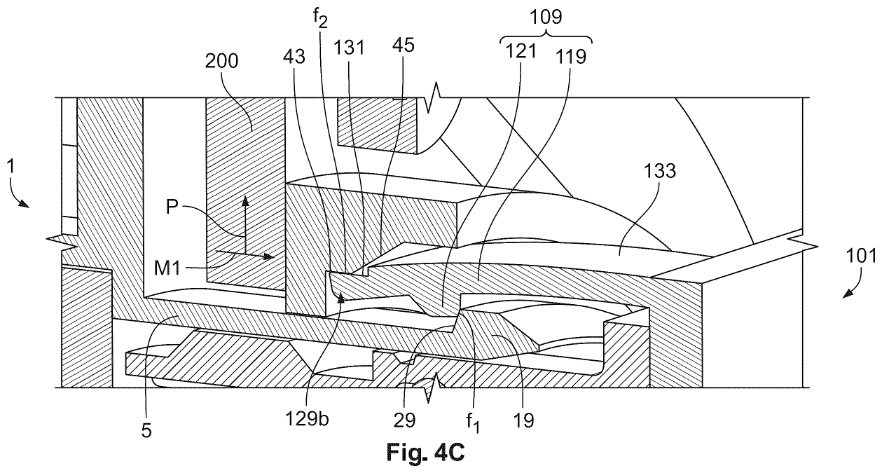

The coupling sequence of the electrical connector 1 and the electrical counter connector 101 will now be described with reference to FIGS. 4A, 4B and 4C.

FIG. 4A shows a cross-sectional view of a peripheral portion of the electrical connector 1 and electrical counter connector 101 of FIG. 1, in a first, unmated state of coupling. The electrical connector 1 and electrical counter connector 101 are aligned along the mating axis M face-to-face such that the housing 3 and the mating housing 103 can be coupled. Specifically, the electrical connector 1 and electrical counter connector 101 are aligned such that the mating shell 107 of the electrical counter-connector 101 is insertable in the coupling space 15, and, at the same time, the insert casing 13 is insertable in the mating coupling space 115.

To facilitate the insertion, in this embodiment the coupling space 15 and the mating coupling space 115 are dimensioned larger, for example more than 20% larger, than their respective counterparts, that is, the mating shell 107 and the insert casing 13. In addition, the distal extremity 47 of the shell 7 is chamfered towards the inward and the outward direction further facilitating the mating of the housings 3, 103. For example, with such an insertion facilitation, the electrical connector 1 and electrical counter connector 101 can be coupled even without visual and/or manual access, which can be the case in some applications when the connector 1 is mounted on the backside of a rack. The connector assembly 100 is thus more user-friendly than connector assemblies requiring visual and/or manual access, for example connector assemblies requiring a manual actuation, for example connector assemblies using threaded portions and/or coupling by turn fastening.

FIG. 4B shows the cross-sectional view of FIG. 4A in a second, intermediate state of the coupling sequence. In this second state, the electrical connector 1 and electrical counter connector 101 are moved together further along mating axis M. Specifically, the electrical connector 1 is moved towards the electrical counter-connector 101, along a direction illustrated as M1 on FIG. 4B, such that the shell 7 is inserted in the latching space 113 and the mating shell 107 is inserted further into the coupling space 15.

As the shell 7 is inserted further into the latching space 113, the protruding portion 19 moves past the mating protrusion 121. Depending on the mutual alignment of the electrical connector 1 and electrical counter connector 101, the mating protrusion 121 can glide along the chamfered part 27 of the protruding portion 19, and the second, free extremity 129b of the lance 119 is received in the receiving space 31, through the receiving opening 39, until abutting on the second surface section 45. As the connector locking device 9 is pushed in the direction M1 parallel to the mating axis M, for example by a pushing on the rack 200, which in turns pushes on the connector locking device 9 through the interface I, the extremity 129b abuts on the second surface section 45. The extremity 129b thus glides along thereon, being elastically bent inwards, towards the outward-facing surface 17 of the shell 7.

In FIG. 4B, the terminals 5, 105 have already abutted, as shown on FIG. 5, and the form-fit F1 described with respect to FIG. 4C is established. However, the coupling sequence is not completed, as the connectors 1, 101 are not securely coupled. Indeed, as the elastic bending of the lance 119 is not stable, as, unless the coupling sequence is completed, the elastic restoring force of the lance 119 would push the connectors 1, 101 back apart, decoupling them.

FIG. 4C shows the cross-sectional views of FIGS. 4A and 4B in perspective, in a third, coupled state of coupling. In the view of FIG. 4C, the rack 200 and the engaged connector locking device 9 have moved further along the direction M1 parallel to the mating axis M, such that the extremity 129b of the lance 119 has slid further along the chamfered second surface section 45. Thus, the extremity 129b elastically bent further inwards, towards the outward-facing surface 17 of the shell 7, such that the mating protrusion 119 has even further latched behind the protruding portion 19 than seen on FIG. 4B.

Specifically, the mating protrusion 119 is lodged in or on the step part 29 of the protruding portion 19, realizing a first form fit connection F1. The first form fit connection F1 locks the hook-shaped latching device 9 of the electrical counter-connector 101 on the shell 7 blocks and separating, uncoupling movements by the electrical connector 1 and electrical counter-connector 101 along the mating axis M.

FIG. 4C also shows that the extremity 129b has slid beyond the second surface section 45 towards the adjacent thereto first surface section 43, extending parallel to the mating axis M. The notch 131, formed on the outward-facing surface 133 of the lance 119, is engaged with the first surface section 43, such that a second form fit connection F2 is realized. Specifically, the notch 131 has a corresponding shape to the parallel first surface section 43, that is, a shape allowing for a plane parallel to the surface 17 of the shell 7 when the lance 119 is bent inwards. The second form fit connection F2 blocks the second extremity 129b in the direction P perpendicular to the mating axis M away from the shell 7 of the electrical connector 1. Thus, the second form fit connection F2 prevents a return of the bent lance 119 to a resting position and a release of the first form fit connection F1. However, the second form fit connection F2 does not prevent translational movement along the mating direction between the connector locking device 9 and the shell 7.

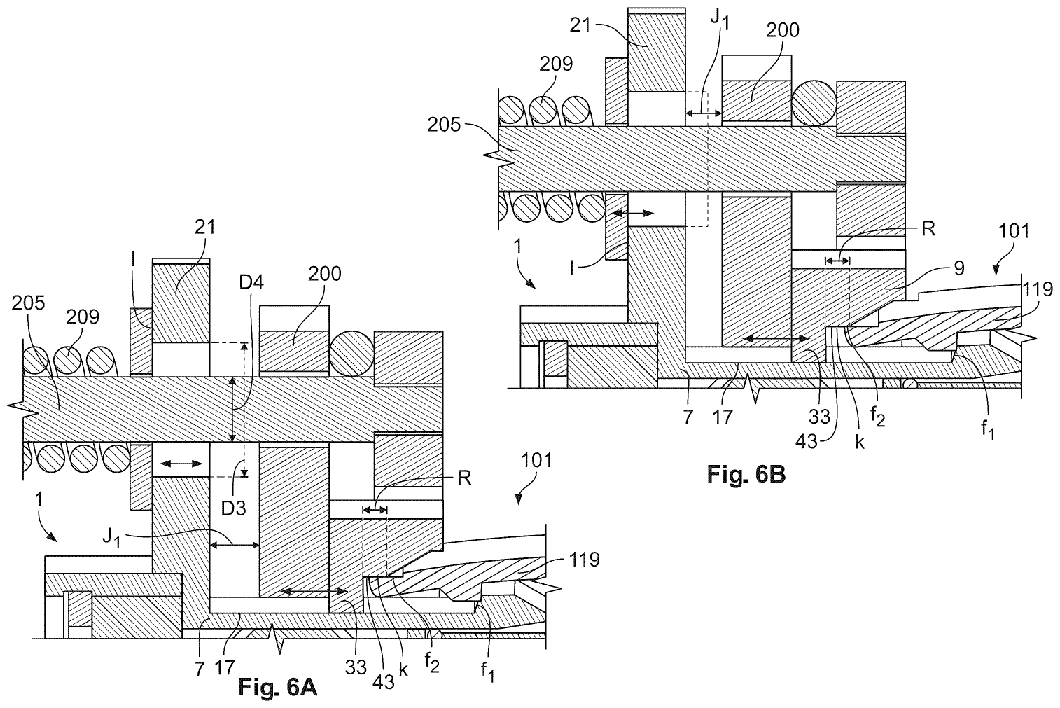

The advantages of the subject matter herein and in particular the above-described exemplary embodiments will be further described in view of FIGS. 5, 6A and 6B. FIG. 5 shows a cross-sectional view of the electrical connector 1, mounted to the rack 200 and mated with the electrical counter-connector 101 in the coupled state partially shown on FIG. 4C. Therefore, FIG. 5 also shows the connector assembly 100 according to an exemplary embodiment.

In the coupled state, the housing 3 and the mating housing 103 are mated such that the electrical terminal 5 abuts on the mating electrical terminal 105. The insert casing 13 is received in the mating coupling space 115 and the mating shell 107 is received in the coupling space 15. In addition, the electric terminals 5, 105 are fully bottomed out at their engagement surface E. In other words, the coupling by pushing on the rack 200 in mating direction M1 has mated the housings 3, 103 such that the electrical terminals 5, 105 have firstly and fully bottomed-out against each other at the engagement surface E.

At the same time, the shell 7 is received in the latching space 113 and the latching device 109 is received in the receiving space 31, such that the form-fit connections F1, F2 described with reference to FIG. 4C are realized with, respectively, the shell 7 and the connector locking device 9. In particular, the form fit F1 blocks any decoupling of the bottomed-out terminals 5, 105, in particular blocks relative motion along the mating axis M. Thus, fretting by longitudinal vibration is not possible.

Further, in this embodiment, the compressed coil springs 209 apply a coupling force F3, parallel to the mating direction M1 and the mating axis M, to the housing 3, via the flange 21 or flange portions 23a, keeping the electrical terminals 5, 105 bottomed-out even in the case of vibrations.

Advantageously, the connector assembly 100 absorbs the difference in vibrational motion between the electrical counter-connector 101, mounted on a frame of the vehicle, and the electrical connector 1. This is illustrated in FIGS. 6A and 6B, showing a close-up view of the section C of FIG. 5. The electrical connector 1, when coupled with the electrical counter-connector 101 in the coupled state, vibrates with the same frequency or motion as the electrical counter-connector 101, and is not impacted by the vibrations of the rack 200.

Indeed, as described with reference to FIG. 3A, the electrical connector 1 is mounted in the rack 200 in a floating state, in which it preserves one or more degrees of freedom even when attaches to an external device. For example, in FIG. 1, the electrical connector 1 has at least three degrees of freedom, one along the mating axis M and two in the directions perpendicular to the mating axis M, and in addition possibly rotational degrees of freedom.

As the rack 200 vibrates longitudinally, along the mating axis M, the pin 205 and the connector locking device 9, positively and/or frictionally engaged with the rack 200 at the interface I, move with the rack 200. The pin 205 does not transmit the vibrations to the shell 7 through the flange 21, as the diameter D3 of the bore 25a is larger than the diameter D4 of the pin 205. The connector locking device 9 does not transmit the vibrations to the shell 7 as it is in sliding contact with the outward facing surface 17. Therefore, no relative movement is induced between the terminals 5, 105, and fretting corrosion from vibrations can be reduced or avoided.

As can be seen on FIGS. 6A and 6B, while the distance J1 between the rack 200 and the flange 21 of the shell can vary with vibrations, the connector 1 remains firmly locked and coupled to the counter-connector 101, as the connector locking device 9 slides with the rack 200 over the interface K parallel to the mating axis M between the notch 131 and the first surface section 43. The interface K extends over the predetermined linear range R, corresponding in this embodiment to the length of the first surface section 43. Thus, the form-fit connections F1 and F2 are secured. The lance 119 remains moveably blocked by the first surface section 43. That is, the lance 119 is blocked in the direction P perpendicular to the mating direction M, but moveable over the predetermined linear range R. Thus, the longitudinal vibrations or relative positional changes of the rack 200 with respect to the shell 7 along the mating axis M are absorbed and fretting corrosion at terminal interface E is reduced.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical connector comprising:
a housing and an electrical terminal configured to be mated along a mating axis with a mating housing and a mating electrical terminal of an electrical counter-connector,
the housing including a shell at least partially surrounding the electrical terminal,
the shell including a protruding portion formed on an outward-facing surface for allowing a form-fit connection along the mating axis with a hook-shaped latching device of the electrical counter-connector,
the housing including a connector locking device at least partially surrounding the shell,
wherein the connector locking device is in a sliding contact with the shell allowing a movement of the connector locking device along the mating axis relative to the shell, and
wherein the connector locking device is configured to block the form-fit connection between the latching device and the protruding portion along a direction perpendicular to the mating axis in a coupled state in which the electrical connector and the electrical counter-connector are coupled.

2. Electrical connector according to claim 1, wherein an inward-facing surface, facing the outward-facing surface of the shell, of the connector locking device forms a receiving space together with the outward-facing surface of the shell, wherein the receiving space has an opening towards the protruding portion of the shell, the receiving space being configured to at least partially receive the latching device through the opening in the coupled state.

3. Electrical connector according to claim 2, wherein the inward-facing surface of the connector locking device includes a first surface section and a second surface section adjacent to the first surface section towards the opening of the receiving space, the first surface section parallel to the outward-facing surface of the shell, wherein the second surface section is chamfered with respect to the mating axis such that the distance between second surface section and the outward-facing surface of the shell gradually increases towards the opening.

4. Electrical counter-connector configured to be mated along a mating axis with an electrical connector, the electrical connector including a housing and an electrical terminal, wherein the housing includes a shell at least partially surrounding the electrical terminal and a protruding portion formed on an outward-facing surface of the shell, the housing including a connector locking device at least partially surrounding the shell, wherein the connector locking device is in a sliding contact with the shell allowing a movement of the connector locking device along the mating axis relative to the shell, the electrical counter-connector comprising:
a mating housing and a mating electrical terminal, configured to be mated along the mating axis with the housing and the electrical terminal of the electrical connector,
the mating housing including a mating shell at least partially surrounding the mating electrical terminal,
the mating housing including a latching device, the latching device being hook-shaped and extending along an outward-facing surface of the mating shell and spaced apart therefrom,
the latching device including a lance extending parallel to the mating axis and including a mating protrusion extending from a surface of the lance facing the outward-facing surface of the mating shell towards said outward-facing surface of the mating shell, for allowing a form-fit connection along the mating axis with the protruding portion of the shell of the electrical connector,
wherein the lance of the latching device has one extremity fixed to the mating shell and a second extremity configured and arranged such that, in the coupled state, the second extremity of the lance is blocked, along the direction perpendicular to the mating axis, by the connector locking device of the electrical connector.

5. Electrical counter-connector according to claim 4, wherein the lance extends perpendicularly from a flange mounted against a mating flange of the mating shell.

6. Electrical counter-connector according to claim 4, wherein latching device further comprises a notch formed at the second extremity on an outward-facing surface opposite the surface of the lance facing the outer surface of the mating shell.

7. Connector assembly comprising:
an electrical connector including a housing and an electrical terminal, the housing including a shell at least partially surrounding the electrical terminal, the shell including a protruding portion formed on an outward-facing surface, the housing including a connector locking device at least partially surrounding the shell, wherein the connector locking device is in a sliding contact with the shell allowing a movement of the connector locking device along the mating axis relative to the shell; and
an electrical counter-connector including a mating housing and a mating electrical terminal configured to be mated along a mating axis with the housing and the electrical terminal of the electrical connector, the mating housing including a mating shell at least partially surrounding the mating electrical terminal, the mating housing including a latching device, the latching device being hook-shaped and extending along an outward-facing surface of the mating shell and spaced apart therefrom, the latching device including a lance extending parallel to the mating axis and including a mating protrusion extending from a surface of the lance facing the outward-facing surface of the mating shell towards said outward-facing surface of the mating shell, for allowing a form-fit connection along the mating axis with the protruding portion of the shell of the electrical connector, wherein the lance of the latching device has one extremity fixed to the mating shell and a second extremity;
wherein the electrical terminal of the electrical connector abuts against the mating electrical terminal in a plane perpendicular to the mating axis,
wherein the protruding portion and the mating protrusion realize a form-fit connection between the latching device and the shell along the mating axis to prevent a decoupling against the coupling direction, and
wherein, in the coupled state, the second extremity of the lance is blocked by the connector locking device in the direction perpendicular to the mating axis away from the shell of the electrical connector.

8. Connector assembly according to claim 7, wherein an inward-facing surface, facing the outward-facing surface of the shell, of the connector locking device forms a receiving space together with the outward-facing surface of the shell, wherein the receiving space has an opening towards the protruding portion of the shell, the receiving space being configured to at least partially receive the latching device through the opening in the coupled state.

9. Connector assembly according to claim 8, wherein the lance of the latching device is bent towards the shell of the electrical connector by the connector locking device by the inward-facing surface of the connector locking device.

10. Connector assembly according to claim 8, wherein the inward-facing surface of the connector locking device includes a first surface section and a second surface section adjacent to the first surface section towards the opening of the receiving space, the first surface section parallel to the outward-facing surface of the shell, wherein the second surface section is chamfered with respect to the mating axis such that the distance between second surface section and the outward-facing surface of the shell gradually increases towards the opening.

11. Connector assembly according to claim 10, wherein latching device further comprises a notch formed at the second extremity on an outward-facing surface opposite the surface of the lance facing the outer surface of the mating shell.

12. Connector assembly according to claim 11, wherein the form-fit connection between the latching device and the connector locking device is realized by an engagement between the notch and the second surface portion.

13. Connector assembly according to claim 12, further comprising a rack for mounting the connector assembly to an external device such that the connector assembly has one or more degrees of freedom when mounted to the external device,
wherein the electrical connector is located in an opening of the rack such that the rack partially extends between a flange of the shell and the connector locking device, wherein the rack is moveable with respect to the shell and frictionally and/or positively engaged with the connector locking device,
wherein the lance remains moveably blocked by the connector locking device over a predetermined linear range of the relative position of the rack with respect to the shell along the mating axis.

14. Connector assembly according to claim 7, further comprising a rack for mounting the connector assembly to an external device such that the connector assembly has one or more degrees of freedom when mounted to the external device,
wherein the electrical connector is located in an opening of the rack such that the rack partially extends between a flange of the shell and the connector locking device, wherein the rack is moveable with respect to the shell and frictionally and/or positively engaged with the connector locking device,
wherein the lance remains moveably blocked by the connector locking device over a predetermined linear range of the relative position of the rack with respect to the shell along the mating axis.

15. Connector assembly according to claim 7, wherein the lance extends perpendicularly from a flange mounted against a mating flange of the mating shell.

16. Connector assembly according to claim 7, wherein latching device further comprises a notch formed at the second extremity on an outward-facing surface opposite the surface of the lance facing the outer surface of the mating shell.
